(19) United States
(12) Patent Application Publication
(10) Pub. No.: US 2026/0252333 A1
(43) Pub. Date: Aug. 27, 2026

(54) SYSTEMS AND METHODS FOR INVENTORY MANAGEMENT AND OPTIMIZATION

(71) Applicant: JPMORGAN CHASE BANK, N.A., New York, NY (US)

(72) Inventors: Rajasekhar ALLADA, Princeton, NJ (US); Pankaj JAIN, Bangalore (IN); Leonid TSVAYBERG, Scotch Plains, FL (US); Gerwig MOOS, New York, NY (US); Priya MUTHYALA, Scotch Plains, FL (US)

(21) Appl. No.: 19/255,126

(22) Filed: Jun. 30, 2025

(30) Foreign Application Priority Data
Feb. 27, 2025 (IN) 202511017230

(51) Int. Cl. G06F 8/61

(52) U.S. Cl. CPC G06F 8/61

(57) ABSTRACT

Techniques described herein relate to a release orchestrator one click execution that may visualize a runbook of steps across one or more applications as a dependency graph. Further, the release orchestrator one click execution may automatically and efficiently execute each heterogenous command of the runbook using a graph traversal technique, thus saving time, resources, and achieving consistency. In some embodiments, the techniques described herein relate to a method including: a release orchestrator application; determining, by the release orchestrator application executed by one or more processors, a setup tool for an application; mapping, by the release orchestrator application, one or more deployment configurations to one or more components and/or pipelines of the application; and determining, by the release orchestrator application, an environment and/or parameter value for the environment.

### BACKGROUND

### 1. Field of The Invention

Aspects generally relate to systems and methods for inventory management and optimization for digital accounts.

### 2. Description of the Related Art

A variety of teams across an organization may deploy and orchestrate implementation of software on local or network systems. Consistency between these software and implementation of the software, being developed in different ways and by different teams, is difficult to obtain. Further, the many different types of applications, the differences in method of deployment, hardware implementation, and cloud and local memory storage, among others, present further challenges in consistency and efficient implementation. Enforcing consistency and rolling out applications efficiently while working correctly may take large amounts of manual work. The complexity of the applications including several operations that needs to be executed during delivery also presents further issues. Thus, there is a need for an orchestrator to organize and roll out applications effectively, efficiently, and with consistency using a single push button that will orchestrate heterogenous implementation in bulk across platforms.

### SUMMARY

Exemplary embodiments provide systems and methods for identity proofing. According to one embodiment, a method may include In some embodiments, the techniques described herein relate to a method including: receiving, by a user electronic device, an identification of an application or a location of an application stored on a memory accessible by the user electronic device and a release orchestrator application, the one or more applications for deployment may include one or more components and/or pipelines; determining, by a release orchestrator application executed by one or more processors, a setup tool for the application; mapping, by the release orchestrator application, one or more deployment configurations to the one or more components and/or pipelines; determining, by the release orchestrator application, an environment and/or parameter value for the environment; executing, by the release orchestrator application, components according to orchestration sequence; determining, by the release orchestrator application, one or more setup credentials in settings or deployment configuration; determining, by the release orchestrator application, a release scope for the application; and deploying, by the release orchestrator application, the one or more applications to the environment.

In some embodiments, the setup tool may be an application programming interface (“API”). In some embodiments, a user interface of the user electronic device may receive a single entry comprising the identification. In some embodiments, the method may further comprise determining, by the release orchestrator application, a parameter value for the environment. In some embodiments, the orchestration sequence may comprise executing one or more batches in parallel. In some embodiments, the orchestration sequence may comprise executing a stop service batch and then a database deploy service batch and a code deploy service batch in parallel, and then a start service batch. In some embodiments, the release orchestrator application may comprise generating a graph with edges representing batches and connections between the edges representing dependencies.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for inventory management and optimization for digital accounts, in accordance with embodiments.

FIG. 2 is a method for inventory management and optimization for digital accounts, in accordance with embodiments.

FIG. 3 is a block diagram of a computing device for implementing certain aspects of the present disclosure.

### DETAILED DESCRIPTION

Aspects generally relate to systems and methods for inventory management and optimization for digital accounts.

In accordance with embodiments, systems and methods may include receiving, by a user electronic device, an identification of an application or a location of an application stored on a memory accessible by the user electronic device and a release orchestrator application, the one or more applications for deployment may include one or more components and/or pipelines; determining, by a release orchestrator application executed by one or more processors, a setup tool for the application; mapping, by the release orchestrator application, one or more deployment configurations to the one or more components and/or pipelines; determining, by the release orchestrator application, an environment and/or parameter value for the environment; executing, by the release orchestrator application, components according to orchestration sequence; determining, by the release orchestrator application, one or more setup credentials in settings or deployment configuration; determining, by the release orchestrator application, a release scope for the application; and deploying, by the release orchestrator application, the one or more applications to the environment.

Techniques described herein relate to a release orchestrator one click execution that may visualize a runbook of steps across one or more applications as a dependency graph. Further, the release orchestrator one click execution may automatically and efficiently execute each heterogenous command of the runbook using a graph traversal technique, thus saving time, resources, and achieving consistency. In some embodiments, the techniques described herein relate to a method including: a release orchestrator application; determining, by the release orchestrator application executed by one or more processors, a setup tool for an application; mapping, by the release orchestrator application, one or more deployment configurations to one or more components and/or pipelines of the application; and determining, by the release orchestrator application, an environment and/or parameter value for the environment.

Disclosed are systems and methods including an orchestrator that enforces consistency between these software and implementation of the software despite differences in method of deployment, hardware implementation, methods of cloud and/or local memory storage, and rolling out applications efficiently and with the applications working correctly. Thus, disclosed is an orchestrator to organize and roll out applications effectively, efficiently, and with consistency using a single entry (e.g., one click, user interface input) that will orchestrate heterogenous implementation in bulk across platforms.

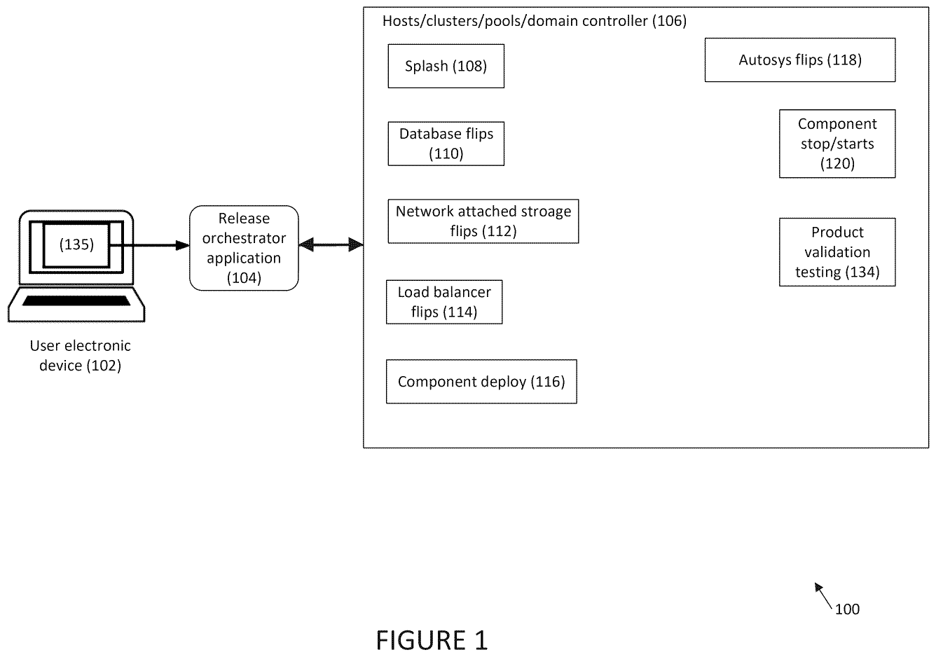

FIG. 1 is a block diagram of a system for identity proofing, in accordance with embodiments. System 100 includes a user electronic device 102 executing a release orchestrator application 104 available through a user interface 135, a number of hosts, cluster, pools, and/or domain controller 106 executing one or more software modules. The one or more software modules may include one or more of a splash module 108, a database flips module, 110, a network attached storage flips 112, a load balancer flips 114, a component deploy 116, an autosys flips 118, a component stop/starts module 120, and/or a product validating testing 134. The number of hosts, cluster, pools, and/or domain controller 106 may include one or more databases referenced by one or more of the software modules.

In accordance with aspects, user electronic device 102 may be a user electronic device such as a personal communication device (e.g., tablet, phone), computer workstation, laptop, or other electronic processing device in operative communication with release orchestrator application 104 and/or financial institution backend 106. User electronic device 102 may be configured to interact with release orchestrator application 104 through user interface 135. For instance, user device 102 may include a client application that allows a user of user electronic device 102 to interact with release orchestrator application 104. User interface 135 may include one or more graphical user interfaces to receive inputs and/or display information to the user. User interface 135 and/or release orchestrator application 104 may comprise one or more instructions executed by one or more processors of user electronic device 102. Release orchestrator application 104 may be a software production application provided by a service organization. In an exemplary aspect, release orchestrator application 104 may be a software deployment application or system.

In some embodiments, splash module 108 may be configured to include executing pre-deployment steps in order to hold new requests coming to the application while application is undergoing a change.

In some embodiments, database flips module 110 may be configured to include switching active database (“DB”) connections to standby instance so that DB changes can be implemented.

In some embodiments, network attached storage flips module 112 may be configured to include switching switch storage to upgraded instance.

In some embodiments, load balancer flips module 114 may be configured to include switching live traffic to secondary instance while software changes are applied on primary instance.

In some embodiments, component deploy module 116 may be configured to include actual deployment of the software using heterogeneous deployment platforms like Ansible®, Jenkins®, Spinnaker®, command line interfaces etc.

In some embodiments, autosys flips module 118 may be configured to include putting active autosys jobs on hold in that the active autosys jobs will no longer run (e.g., on ice) before software changes can be implemented.

In some embodiments, component stop/starts module 120 may be configured to include stopping the software services before changes can be implemented and starting the software services post change implementation.

In some embodiments, product validation testing module 134 may be configured to include executing application health checks, running functional test and ensuring software change is implemented correctly without breaking overall application functionality.

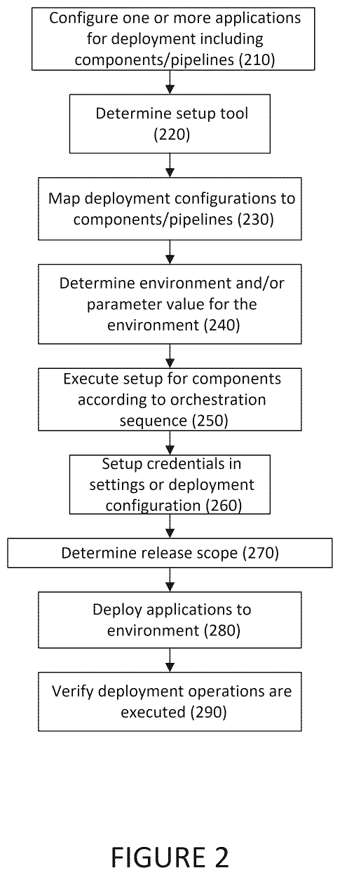

FIG. 2 is a method for identity proofing, in accordance with some embodiments. The method may be stored as a list of instructions stored on a memory that when executed by one or more processors cause the one or more processors to perform the method.

Step 240 may include determining an environment and/or parameter value for the one time environment setup. The environment may be named, the type may be identified, and a host and/or server name may be identified. The mapping may include pre-populating one or more containers, a collection, and/or a component of the environment.

Step 250 may include one time setup for components orchestration sequence. Components in the same batch may be executed in parallel. A batch may be a collection of tasks. Components in a higher batch (of a higher order in a hierarchy of the orchestration sequence) are executed next. For example, during execution, the release orchestrator application may first pick stop services batch and once batch is completed successfully it will trigger database deploy services and code deploy services in parallel. Once both deploy batches are done, it will automatically trigger Start Services. Thus, the release orchestrator application may traverse any complicated graph and automatically execute all steps following dependency order and highlighting states using color coding. In some embodiments, the release orchestrator application may generate a graph with edges representing batches and connections between the edges representing dependencies. The batch with the least edges may be of a lower order and may be executed first. In some embodiments, one or more related components are grouped in a same batch and dependent components are grouped in another batch during orchestration setup. During deployment, release orchestrator may automatically find dependencies iterating these batches, wherein the determination of the dependencies may be based on the graph.

Step 260 may include determining setup credentials in settings or deployment configuration. Setup credentials may be retrieved from a memory. Setup credentials, such as a password, may be retrieved from a vault or a specifying runtime parameter.

Step 270 may include determining a release scope after all above one time setup is complete. The release scope may identify a number of tasks. Each task may be a command that can be orchestrated on any target platform. Determining the release scope may include selecting a subset of components that are part of a release, for example, by simple checkbox selection or a determination of needed components based on past rollouts of similar applications. The determination of needed components may be conducted by a machine learning model in operative communication with the release orchestrator, wherein the release orchestrator may generate a message or API call to the machine learning model to determine the necessary components based on components used by past applications and a comparison of features of the past applications and the one or more applications to be rolled out. Determining the release scope may include providing one or more runtime parameters. Runtime parameters may be a value supplied to a script and/or task at runtime.

Step 280 may include deploying the one or more applications to the environment. Deploying the one or more applications may include overriding the environment or runtime parameter including one or more passkeys. Deploying the one or more applications may include executing release with one input such as a keystroke or click received from the user electronic device. Deploying the one or more applications may include executing end to end pipelines in response to the user input.

Step 290 may include verifying all deployment operations are executed as expected using sanity checks, functional and non-functional testing.

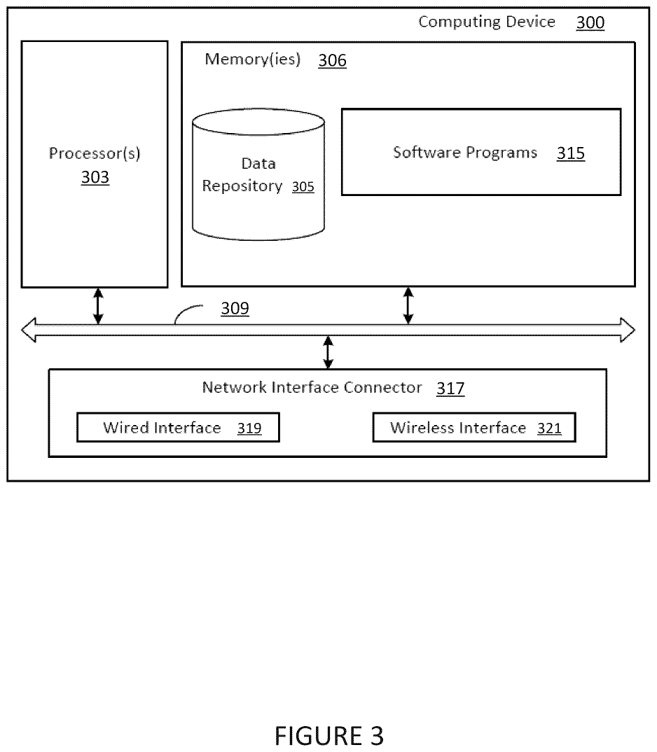

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, by a user electronic device, an identification of an application stored on a memory accessible by the user electronic device and a release orchestrator application, the one or more applications for deployment including one or more components and/or pipelines of the one or more applications, respectively;
determining, by a release orchestrator application executed by one or more processors, a setup tool for the application;
mapping, by the release orchestrator application, one or more deployment configurations to the one or more components and/or pipelines;
determining, by the release orchestrator application, an environment for the one or more applications;
executing, by the release orchestrator application, components according to orchestration sequence;
determining, by the release orchestrator application, one or more setup credentials in settings or deployment configuration;
determining, by the release orchestrator application, a release scope for the application;
deploying, by the release orchestrator application, the one or more applications to the environment; and
deploying, by the release orchestrator application, the one or more components to the environment.

2. The method of claim 1, wherein the setup tool is an application programming interface (“API”).

3. The method of claim 1, wherein a user interface of the user electronic device receives a single entry comprising the identification.

4. The method of claim 1, further comprising determining, by the release orchestrator application, a parameter value for the environment.

5. The method of claim 1, wherein the orchestration sequence comprises executing one or more batches in parallel.

6. The method of claim 1, wherein the orchestration sequence comprises executing a stop service batch and then a database deploy service batch and a code deploy service batch in parallel, and then a start service batch.

7. The method of claim 1, wherein the release orchestrator application comprises generating a graph with edges representing batches and connections between the edges representing dependencies.

8. A method comprising:
receiving, by a user electronic device, a location of an application corresponding to a memory accessible by the user electronic device and a release orchestrator application, the one or more applications for deployment including one or more components and/or pipelines of the one or more applications, respectively;
determining, by a release orchestrator application executed by one or more processors, a setup tool for the application;
mapping, by the release orchestrator application, one or more deployment configurations to the one or more components and/or pipelines;
determining, by the release orchestrator application, an environment for the one or more applications;
executing, by the release orchestrator application, components according to an orchestration sequence;
determining, by the release orchestrator application, one or more setup credentials in settings or deployment configuration;
determining, by the release orchestrator application, a release scope for the application;
deploying, by the release orchestrator application, the one or more applications to the environment; and
deploying, by the release orchestrator application, the one or more components to the environment.

9. The method of claim 1, wherein the setup tool is an application programming interface (“API”).

10. The method of claim 1, wherein a user interface of the user electronic device receives a single entry comprising the identification.

11. The method of claim 1, further comprising determining, by the release orchestrator application, a parameter value for the environment.

12. The method of claim 1, wherein the orchestration sequence comprises executing one or more batches in parallel.

13. The method of claim 1, wherein the orchestration sequence comprises executing a stop service batch and then a database deploy service batch and a code deploy service batch in parallel, and then a start service batch.

14. The method of claim 1, wherein the release orchestrator application comprises generating a graph with edges representing batches and connections between the edges representing dependencies.
